(19) United States
(12) Patent Application Publication
(10) Pub. No.: US 2011/0145132 A1
(43) Pub. Date: Jun. 16, 2011

(54) REMOTE TRANSACTION METHOD AND SYSTEM OF AN ON-LINE PLATFORM FOR FLOATING-RATE FUND-TRADING

(76) Inventor: Yung-Sung CHIEN, Taipei (TW)

(21) Appl. No.: 13/034,935

(22) Filed: Feb. 25, 2011

Related U.S. Application Data
(63) Continuation-in-part of application No. 12/111,946, filed on Apr. 29, 2008.

(30) Foreign Application Priority Data
Apr. 30, 2007 (TW) 96115421

(51) Int. Cl. G06Q 40/00

(52) U.S. Cl. 705/37

(57) ABSTRACT

The present invention provides a remote transaction method and system of an on-line platform for auctioning of money applied in the field of financial e-commerce. Nodes are disposed on the Internet to expand the market of fund-trading platform in the virtual network communities, to enhance the efficiency of operations in the financial market and realize the goal of de-intermediation and de-centralization of direct finance. A node helps a member to establish a platform account via a related connection network and interface, and helps the member to acquire a necessary loan amount for an intended fund-bidding pool by means of loan amount application and providing collateral. A subordinate member attends fund-bidding directly via the platform, or enters the platform via a node, according to his preference. The platform helps node members enter the platform and attend fund trading and monitors the credit-risk status of nodes and members.

The present invention is a continuous-in-part application of the application that is entitled “REMOTE TRANSACTION METHOD AND SYSTEM OF AN ON-LINE PLATFORM FOR FLOATING-RATE FUND-TRADING” (Application NO.: U.S. Ser. No. 12/111,946), which is filed presently with the U.S. Patent & Trademark Office, and which is used herein for reference in its entirety.

### BACKGROUND OF THE INVENTION

1. Field of the Invention

The present invention relates to a remote transaction method and system of an on-line platform for auctioning of money to provide financial services, utilizing software and hardware technologies to implement platform management, network node construction, and remote trading.

2. Description of the Related Art

Traditional banks play a role of broker between depositors and borrowers. The bank absorbs funds from depositors at a lower interest rate and loans funds to borrowers at a higher interest rate and thereby gain from difference of the interest rates. This is called indirect finance. The reason why a depositor is willing to accept a lower interest rate and a borrower is willing to pay a higher interest rate is that informational inefficiency and asymmetry exist between the demand and supply parties. Since the fund parties lack a channel to meet and deal, completing the demand and supply of fund trading by themselves is costly and time-consuming. Since a fund supplier (depositor) is unlikely to be fully informed of the credit state of a borrower, the fund supplier would rather deposit his money into a bank and sacrifice part of his interest rather than have a bad debt. This is the above-mentioned information asymmetry. Therefore, some financial advisors say that the banks profit from the asymmetry of information in the age of indirect finance.

With the emergence of the Internet, the barrier between the demand and supply of fund parties has been obviously reduced. If Internet technology can cooperate with an effective mechanism, the informational cost for direct trading between loaners and borrowers can be greatly lessened. As to the information asymmetry, an Internet platform can promote the information transparency for the participants via customers' data and credit analysis procedures. The platform can also perform credit risk management and contract default prevention measures to further reduce the asymmetry of information.

In the financial circle, efforts have been made to improve the inefficiency in the traditional financial system. Constrained by technology, it has been hard to break through the rut of information exchange between loaners and borrowers. However, Internet technology provides a solution to break through the inefficiency of indirect finance. Under such background, reformers of financial market have contrived to come up with ways to utilize the Internet to create new, direct finance method of deposit and borrowing funds.

In 2005 a company in England called ZOPA (www.zopa.com) proposed a risk-sharing deposit and loan platform for both borrowers and loaners. Although the scheme resembles the deposit and loan method of direct finance, there is too much manual operation involved. Additionally, the scheme can only be applied to microfinance.

US patent application No. 2006/0224502A1 discloses a “System and Method for On-line Peer-to-Peer Banking.” US patent application No. 2007/0073613A1 discloses a “Simultaneous Bidding and Matching Platform for Loan Borrower and Lender,” which refers to a mode that depositors and borrowers fill bidding forms in a trade matching mechanism. China patent application No. 200610152658.X discloses a “Platform for Loaners and Borrowers Bidding Simultaneously.” However, the above-mentioned patents only enhance the conventional operational patterns of financial products and do not propose an optimized Internet-age deposit and loan mechanism. Thus, the applicability and developing potential thereof are not as expected.

Although the new modes of current electronic finance have not influenced the game rules of traditional indirect finance, which existing banks still rely on, however, Taiwan patent No. 00497059 discloses an “Overdraft Control Finance Administration Method” which introduces a concept of fund-bidding pools able to facilitate an x immediate and friction-free fund trading mode of direct finance in the Internet age.

The above-mentioned “Overdraft Control Finance Administration Method” proposes an innovative and practicable scheme of on-line finance development that relies on Internet nodes and a fund-trading platform to shorten the distance between the depositor and the borrower, and realizes the concept of direct finance. However, on-line finance still needs effective measures and mechanisms to fully exploit the competitive advantage of an on-line fund trading platform.

Therefore, there is a need for an efficient remote transaction method and system of an on-line platform for auctioning of money that utilizes software and hardware technologies to implement platform management, network node construction and remote trading.

### SUMMARY OF THE INVENTION

To achieve these and other advantages and in order to overcome the disadvantages of the conventional method in accordance with the purpose of the invention as embodied and broadly described herein, the present invention provides a remote transaction method and system of an on-line platform for auctioning of money utilizing software and hardware technologies to implement platform management, network node construction and remote trading.

The present invention provides conceptions of Internet nodes and remote transaction fund trading, wherein network nodes are organized to function as routes to develop platform business, and wherein the autonomous and flexible operation modes make Internet finance more efficient for depositors and borrowers. Thereby, the fund trading platform achieves the utmost efficiency and advances the realization of direct finance with an immediate and friction-free fund trading mode. Additionally, the popularization of the broker-free financial service will bring about a great jump in the efficiency of the entire financial market.

To realize the functions the present invention achieves, the following facilities are constructed: (1) a server processing information for the platform; (2) databases storing and administrating the data of fund trading, settlement and delivery; (3) a linking device implementing data transmission among the platform, nodes and members; and (4) related software providing input interfaces, performing links between different systems and executing tasks.

The present invention provides a remote transaction method and system of an on-line platform for auctioning of money (a platform for short hereafter), which is a direct-finance electronic business reflecting the advancement in Internet technology, wherein effective Internet technology is used to unite depositors and borrowers and create opportunities of immediate contacts between them. Via the bidding mechanism and the contract default prevention mechanism, the present invention achieves optimized fund disposition and optimal operation efficiency. Thus, the present invention not only provides financial customers with more favorable conditions but also revolutionizes the management pattern of traditional indirect finance that profits from the difference of interest rates.

In the financial market, an innovative trading mechanism needs effective market development to manifest its efficacy. Marketing personnel are the main force in traditional financial marketing. Confined to the conventional system, marketing personnel are subject to lacking initiative and flexibility. The traditional financial marketing is usually realized by telemarketing or personal visits. Therefore, the efficiency, coverage, and levels of marketing are intrinsically limited. The present invention utilizes the global Internet and extends the concepts of network nodes and remote transactions of electronic commerce to enable each node to be a marketing agent capable of autonomously developing potential markets. Because the remote transaction fund trading is free of geographical limitations, a member, no matter where he is, can attend the fund bidding of the platform via a network node. Additionally, the node provides other financial services such as making loans if customers ask for it.

The present invention integrates the advantages of nodes and remote transaction fund trading to expand financial services to everywhere. Thus, the globally-spreading financial service of the present invention can overcome the inefficiency of the current locality-confined financial services and optimize fund disposition. The present invention converts the current concepts of physical (material service) and indirect (intermediary) financial management into a virtual (Internet trading) and direct (agent-free) concept and arrives at a de-centered and broker-free financial service. Compared with the traditional indirect-finance business and other Internet-based loan mechanisms, the present invention has the following characteristics:
1. An objective of the present invention is to provide an Internet-based direct-finance deposit and loan system to create opportunities of immediate and friction-free contacts for depositors and loaners, whereby both parties can undertake fund trading with a lower cost and higher efficiency.
2. Another objective of the present invention is to de-centralize the platform, wherein the nodes function as the sub-centers of financial service, and the platform transforms from a sole center to a coordinator of the nodes.
3. Another objective of the present invention is to integrate depositors and borrowers and de-broker financial services, whereby the bank transforms from a financial broker to a financial service provider and a direct-finance market developer. Thus, the niche of the financial business is changed, and the bank no longer profits from interest rate differences but from service charges.
4. Another objective of the present invention is to make every node a marketing base, a virtual community of members, an administrator, and a service provider, whereby the services of the fund platform are spread everywhere and popularize the financial services.
5. The present invention comprises a reward mechanism, which encourages members to create and share profits, whereby the efficiency of the platform greatly increases and the market of the platform grows exponentially.
6. With the development of virtual communities, the present invention spontaneously facilitates the formation of Internet-based marketing teams. The financial organization originally operating the platform transforms from a sole service supplier to an administrator of the nodes. The banks spend less on marketing but make the best of their functions of credit analysis and risk management.
7. The present invention establishes nodes and confers the management of the nodes on legal and suitable persons, which will benefit employment, financial efficiency, and economic growth.
8. In the present invention, a node applies for a loan amount and increases collateral to expand its loan amount. The node provides loan amounts to its subordinate members and directly monitors the credit states of the subordinate members. Thus, the burden of risk management on the platform decreases.
9. In the present invention, the settlement and delivery center is independent from the platform. The platform is dedicated to trading-related affairs, such as fund-bidding and credit surveillance. The settlement and delivery center processes the settlement and delivery of funds. Such a design has an advantage of separating fund management from product management, which promotes the efficiency of market operation.
10.In the present invention, the settlement and delivery center is a member-based system, and the operator of the settlement and delivery center is not limited to the financial organization operating the platform. Other financial organizations may also be members of the settlement and delivery center. For customers' convenience, a node may introduce a customer to establish his settlement and delivery account in a financial organization having membership of the settlement and delivery center. Thereby, members can more conveniently manage his funds at a lower cost, and the efficiency of the platform is also improved.

To achieve the above-mentioned objectives, the present invention provides a remote transaction node for an on-line platform for auctioning of money. A legal representative (such as a financial organization, government corporation, large enterprise, small and medium-sized enterprise, etc.) or an individual applies to the platform in order to become a node of the platform. A node applies to the platform for a loan amount for the node itself to attend the fund bidding or providing loan amounts to their subordinate members. One that intends to attend the platform establishes a platform account via a node to acquire membership to the platform. A member of the platform enters the user interface of the platform via the Internet to attend the fund-bidding pools of the platform. A member of the platform has to further establish a settlement and delivery account in the settlement and delivery center. When a subordinate member of a node succeeds in opening an account or wins a bid, the platform awards the node an open-account bonus or a bid-winning bonus. If a node provides a loan amount for a member, the node acquires a loan-guarantee income from the platform.

The present invention provides a remote transaction system of an on-line platform for auctioning of money, which comprises a platform system and at least one node system. The platform system has an administrating server, which links to members via a member interface, links to nodes with a node interface and links to a settlement and delivery center, through the Internet, a local area network, a wireless communication device or a wired communication device. The administrating server examines applications for becoming a node of the platform and assigns an appropriate loan amount to a node in response to the node's requirement. The administrating server examines the members' application data, which nodes send to the platform, and undertakes credit analysis and examination of loan applications. The administrating server processes members' logging into the platform, members' attending fund-bidding groups, the settlement and delivery of members' funds with the settlement and delivery center, and the calculation and allocation of bonuses and revenue for nodes. The remote transaction system for an on-line platform for auctioning of money further comprises: a node database, a member database, a credit and risk management database, a fund-bidding group database, and a settlement and delivery database.

The node system has a subordinate member database storing the fundamental data, credit analysis data, loan amount data, and fund-bidding data of the subordinate members. The node system comprises four interfaces: a loan amount trial table interface, a bonus and income interface, a node's working interface and a node's member interface.

In accordance with one aspect of the present invention, a remote transaction method of an on-line platform for auctioning of money is provided, wherein the remote transaction method is implemented on a transaction system with an administrating server, and the remote transaction method comprising steps of:

(A) the administrating server receiving an application requested by a first applicant who is a user to become a node, said first applicant using a terminal linking to said administrating server via a network, said administrating server examining whether said first applicant qualifies for being a node; said administrating server approving said first applicant to become a node; said node applying to said administrating server for a loan amount; said administrating server examining whether said node qualifies for a loan amount; said administrating server assigning a loan amount to said node; said node recruiting members;

(B) the administrating server receiving another application by a second applicant who is a user for being a member via said node and establishing a platform account for said second applicant; said member determining whether to apply to said administrating server or to said node for a loan account; allowing said member to enter said administrating server and attend fund-trading activities in said administrating server; said member establishing a settlement and delivery account in a settlement and delivery center;

(C) the administrating server transmitting fund trading data of said member to said settlement and delivery center by said administrating server to perform settlement and delivery of said settlement and delivery account; and said administrating server issuing bonuses to said node according to account establishing and fund trading data of said member.

Preferably, the step (A) further comprising the steps of:

(A1) the administrating server approving said applicant to become a node if said first applicant qualifies and rejecting said applicant if said first applicant does not qualify;

(A2) the administrating server receiving an application from said node for a loan amount; and examining whether said node qualifies for a loan amount;

if said node qualifies for a loan amount, said the administrating server assigning a fundamental loan amount to said node; said administrating server determining whether said node needs to provide collateral for an additional loan amount; if said node provides collateral, said the administrating server examining whether said collateral qualifies;

if said collateral qualifies, said the administrating server assigning said node a secured loan amount; and said node being a node having said fundamental loan amount and said secured loan amount.

Preferably, said node determines whether to apply to said administrating server for a loan amount; if said node chooses not to apply to said administrating server for a loan amount, said node becomes a node without any loan amount.

Preferably, said the administrating server examines whether said node qualifies for a loan amount; if said node does not qualify for a loan amount, said node becomes a node without any loan amount.

Preferably, said node determines whether to provide collateral to enhance loan amount; if said node chooses not to provide collateral to enhance loan amount, said node becomes a node having said basic loan amount.

Preferably, said the administrating server examines whether said collateral qualifies; if said collateral does not qualify, said node becomes a node having said basic loan amount.

Preferably, the step (B) further comprising:
(B1) said node recruiting members for said administrating server;
(B2) said administrating server receiving an application on-line filled out by said second applicant via said node;
(B3) said administrating server examining whether said second applicant qualifies for being a member; if said second applicant does not qualify, said administrating server rejects said applicant; if said applicant qualifies, said applicant becomes a member;
(B4) said administrating server asking said member whether to apply to said administrating server for a loan amount; if said member chooses to apply for a loan amount, said administrating server receiving an application with a loan amount form the member on-line via said node; and
(B5) said administrating server examining whether said member qualifies for a loan amount; if said member qualifies for a loan amount, said administrating server assigning said member a loan amount; and approving said member to attend fund trading.

Preferably, if said member determines said loan amount is insufficient, said member determines whether to apply to said node for a loan amount; if said member chooses to apply to said node for a loan amount, said node examines whether said member qualifies for a loan amount in said node; if said member qualifies, said node assigns another loan amount to said member and sends a report to said administrating server; and the administrating server approves said member to attend the fund trading with new loan amount; if said member choose not to apply to said administrating server for a loan amount or does not qualify for a loan amount in said node, said member directly enters said administrating server and attends fund trading.

Preferably, the step (B5) said administrating server examining whether said member qualifies for a loan amount; if said member does not qualify for a loan amount, said member determines whether to apply to said node for a loan amount; if said member chooses to apply to said node for a loan amount, said node examines whether said member qualifies for a loan amount in said node; if said member qualifies for a loan amount in said node, said node assigns a loan amount to said member and reports to said administrating server, and said member enters into fund trading; if said member chooses not to apply to said node for a loan amount or does not qualify for a loan amount, said member directly enters said administrating server and attends fund trading.

Preferably, said member applies to said administrating server for a loan amount; if said member chooses not to apply to said administrating server for a loan amount, said member determines whether to apply to said node for a loan amount; if said member chooses to apply to said node for a loan amount, said node examines whether said member qualifies for a loan amount in said node; if said member qualifies, said node assigns another loan amount to said member and reports to said administrating server; said member then enters said administrating server and attends fund trading; if said member chooses not to apply to said node for a loan amount or does not qualify for a loan amount in said node, said member directly enters said administrating server and attends fund trading.

Preferably, the remote transaction method further comprising steps: after the administrating server succeeds in establishing an amount for said member in said administrating server, said the administrating server issuing and transferring a message for said node to obtain a open-account bonus; and after said member wins a bid and becomes a borrower member, said administrating server issuing and remitting a message for said node to obtain a bid-winning bonus.

Preferably, if said node guarantees a loan amount for a member, said administrating server further issues a message for said node to obtain an loan-guarantee income.

In accordance with another aspect of the present invention, a fund transaction method is provided, wherein the fund transaction method is implemented on a transaction system with an administrating server. The fund transaction method comprises the steps of:

(A) configuring the administrating server to receive an application from a first user to be a platform node;

(B) configuring the administrating server to set a node credit line of the first user;

(C) configuring the administrating server to receive an application from a second user to be one of platform members;

(D) configuring the administrating server to receive an application from a third user guaranteed by the platform node to be one of platform members;

(E) configuring the administrating server to set a member credit line of the platform member; and

(F) configuring the administrating server to accept the platform member participating in a fund bidding transaction;

wherein the deficiency of the third user's credit line in the fund bidding transaction is guaranteed by the platform node according to the node credit line thereof.

Preferably, the fund transaction method further comprises the steps of:

(G) configuring the administrating server to determine a first reward the platform deserved according to the number of the platform members the platform nodes recruited;

(H) configuring the administrating server to determine a second reward the platform deserved according to a fund bidding transaction result of the platform member the platform nodes recruited; and

(I) configuring the administrating server to determine a third reward the platform node deserved according to the amount of credit line that is guaranteed by the platform node.

Preferably, the fund bidding transaction further comprises the steps of:

(F1) configuring the administrating server to accept the platform member participating in an fund combination to be one of combination members thereof, wherein the fund combination has N combination members and proceeds with N terms;

(F2) configuring the administrating server to receive a bid price submitted by the combination member in a n-th term;

(F3) configuring the administrating server to determine a bid winner of the n-th term according to the whole bid prices submitted by the combination members thereof;

(F4) configuring the administrating server to transmit a first message to prompt a bid winner of the n-th term to obtain a combination fund; and

(F5) configuring the administrating server to transmit a second message to prompt a bid loser of the n-th term to pay a deposit, and transmit a third message to prompt a bid winner of the anterior term to pay a repayment;

wherein the amount of the combination fund of the n-th term is a sum of the deposits and the repayments, and each combination member of the auction combination is limited to be once bid winner during the whole N terms thereof.

Preferably, the fund bidding transaction further comprises the step of:

(F6) configuring the administrating server to transmit a fourth message for charging a service fee from the bid winner.

Preferably, the amounts of the combination fund, the deposit, and the repayment of the fund combination are determined by the following formula:

An=(U−In)×((N−n))+(U×(n−1));

wherein An denotes the amount of the combination fund; U denotes a unit price; N denotes the total number of the terms of the auction combination; n denotes the number of n-th term; and In denotes the bid price submitted by the bid winner of the n-th term;

wherein the bid winner of the n-th term is provided with the combination fund and is prompted to pay U as the repayment price at every remaining repayment term; and the bid loser of the n-th term is prompted to pay (U−In) as the deposit.

Preferably, the amounts of the combination fund, the deposit, and the repayment are determined by the following formula:

$$An = ( U \times ( N - n ) ) + ( U \times ( n - 1 ) ) + {\sum }_{i = 1}^{n - 1} Ii ;$$

wherein An denotes the amount of the combination fund; U denotes a unit price; N denotes the total number of the terms of the auction combination; n denotes the number of n-th term; and Ii denotes the bid price submitted by the bid winner of the anterior i-th term; In denotes the bid price submitted by the bid winner of the n-th term;

wherein the bid winner of the n-th term is provided with the combination fund and is prompted to pay (U+In) as the repayment price at every remaining repayment term; and the bid loser of the n-th term is prompted to pay U as the deposit.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further illustration of the invention, and are incorporated in and constitute a part of this specification. The drawings demonstrate embodiments of the invention and, together with the description, serve to explain the principles of the invention. In the drawings:

FIG. 1 is a flowchart illustrating the remote transaction method of an on-line platform for auctioning of money according to an embodiment of the present invention;

FIG. 2 is a flowchart illustrating the method for becoming a node of an on-line platform for auctioning of money according to an embodiment of the present invention;

FIG. 3 is a flowchart illustrating the method for a user to apply for becoming a member of a node according to an embodiment of the present invention;

FIG. 4 is a flowchart illustrating the method for a node to acquire income and bonus according to an embodiment of the present invention; and

FIG. 5 is a diagram illustrating a remote transaction system of an on-line platform for auctioning of money according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

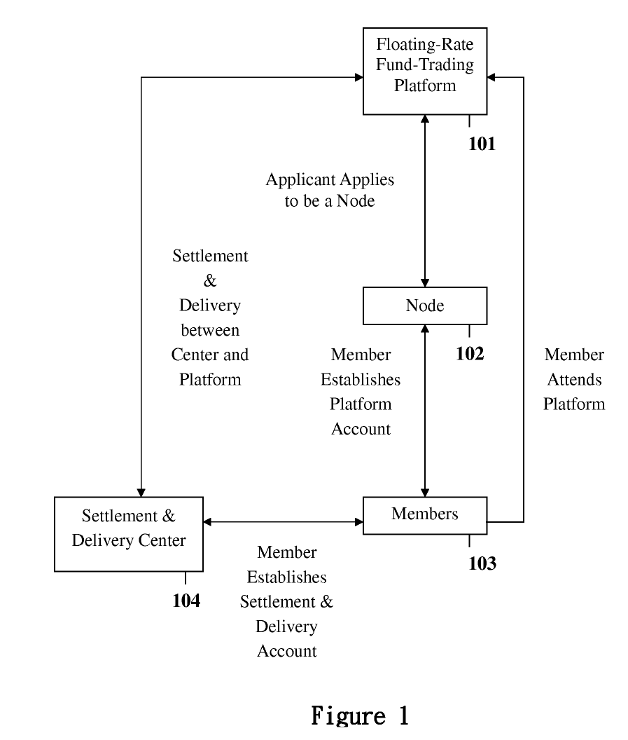

Refer to FIG. 1, which is a flowchart illustrating a remote transaction method of an on-line platform for auctioning of money according to an embodiment of the present invention. A legal representative or an individual, who intends to become a node, applies to the floating-rate fund-trading platform (101) for becoming a node (102). Once the node applicant becomes a node, the node begins to recruit members (103). The node uses its system to undertake a member's account-opening procedure to establish a platform account for the member (103). The member uses the account to link to the platform and attend fund-bidding pools. The member has to further establish a settlement and delivery account in a settlement and delivery center (104) for the later fund transfer there between. The settlement and delivery center (104) undertakes the settlement and delivery of the fund transfer between the member and the platform (101).

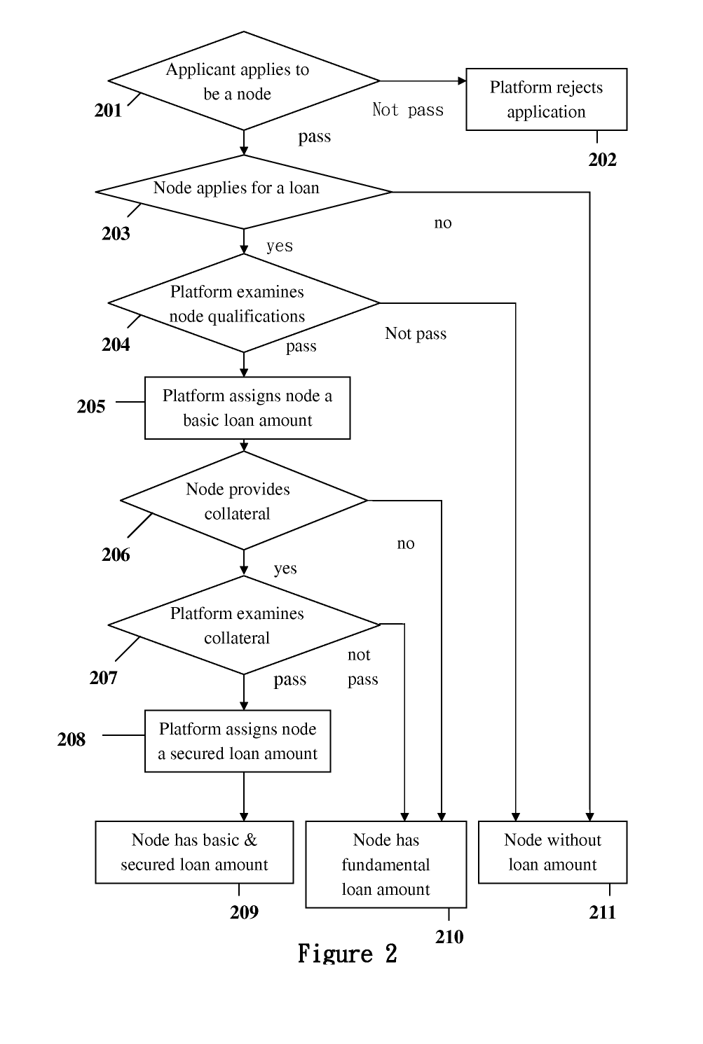

Refer to FIG. 2, which is a flowchart showing the method for applying to become a node of an on-line platform for auctioning of money according to an embodiment of the present invention. A legal representative or an individual person, who intends to be a node, applies to the floating-rate fund-trading platform for becoming a node (Step 201). The platform examines the data of the applicant. If the applicant does not qualify, the platform rejects the application (Step 202). If the applicant passes the examination, the applicant becomes a node. A node determines whether to apply for a loan amount (Step 203). If the node chooses not to apply for a loan amount, the node becomes a node without any loan amount (Step 211). If the node decides to apply for a loan amount, the platform examines the qualifications of the node for a loan amount (Step 204). If the node does not qualify for a loan amount, the node is still a node without any loan amount (Step 211). If the node qualifies for a loan amount, the platform provides a fundamental loan amount for the node (Step 205). The fundamental loan amount is a fiduciary loan amount the platform assigns to the node. If the node determines that the fundamental loan amount is sufficient, the node becomes a node with a fundamental loan amount (Step 210). If the node determines that the fundamental loan amount is less than expected, the node applies to the platform for an increased loan amount by providing collateral (Step 206). The collateral may be in a form of estate mortgage or other collateral. Once the platform receives a node's application for increasing its loan amount, the platform will evaluate the collateral (Step 207). If the collateral does not pass, the node is still a node with a fundamental loan amount (Step 210). If the collateral passes, the platform will assign a secured loan amount (Step 208). The secured loan amount is determined by the evaluation of the collateral. Thus, the node becomes a node with both the fundamental loan amount and the secured loan amount (Step 209).

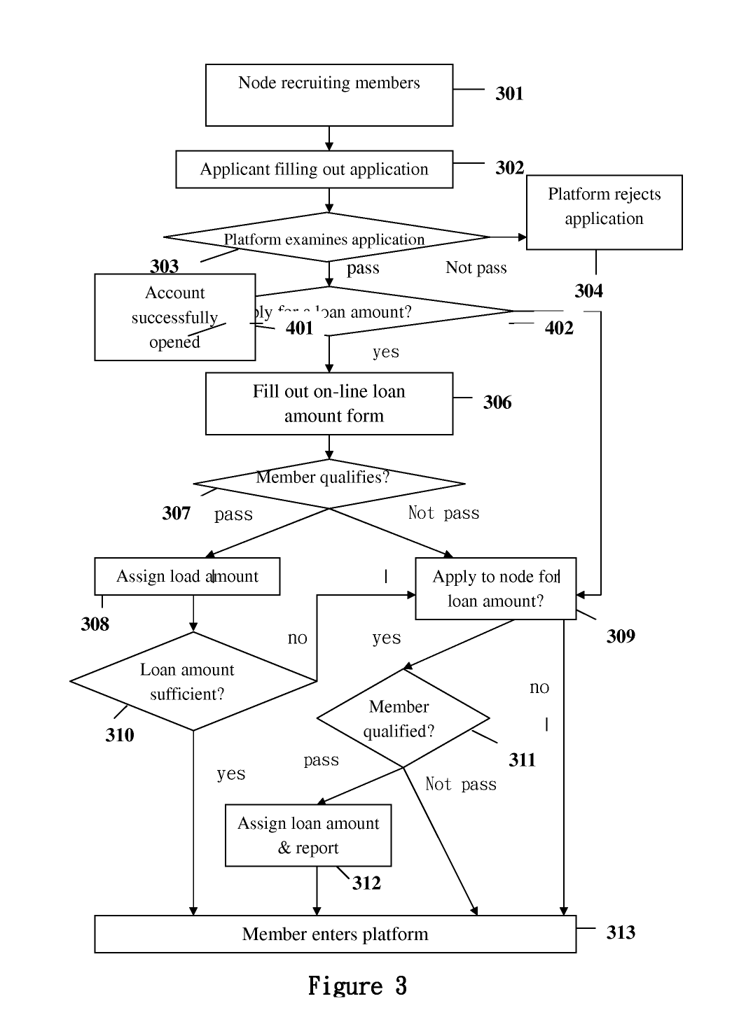

Refer to FIG. 3, which is a flowchart showing the method for becoming a member of a node according to an embodiment of the present invention. After becoming a node of the platform, the node begins to recruit members of the floating-rate fund-trading platform (Step 301). If the node is an organization, the node uses the human resource data of the employees and the related personnel to recruit members. If the node is an individual, he can use a marketing means to recruit members. A customer, who intends to attend the platform, fills out the application form on-line and sends the form through the node to the platform via the Internet (Step 302). The form is used to provide examination data for the platform, to open a platform account for the member, and to open a settlement and delivery account for the member in the settlement and delivery center. The node system sends the completed form the applicant filled out on-line to the platform system and the settlement and delivery center. The platform system and the settlement and delivery center examine the application data on the form (Step 303). If the application data does not pass, the platform rejects the application (Step 304). If the application data passes, the applicant becomes a member. The member determines whether to apply to the platform for a loan amount via the node system (Step 305). If the member chooses not to apply to the platform for a loan amount, he may determine whether or not to apply to the node for a loan amount (Step 309). If the member chooses not to apply to the node for a loan amount, he can directly enter the platform (Step 313) to attend fund-bidding pools. The member without a loan amount cannot bid until he applies and acquires a loan amount or until his deposits increase and spontaneously create a credit amount. If the member chooses to apply to the node for a loan amount (Step 309), the node examines the data the member provided earlier (Step 311). If the data passes the examination, the node assigns a loan amount to the member and notifies or acknowledges the platform (Step 312). Then, the member enters the platform (Step 313) with his loan amount and bids in fund-bidding pools. If the data does not pass the examination of the node, the member can only enter the platform (Step 313) with a no-credit status. The no-credit member cannot bid in the platform until he applies and acquires a loan amount or until his deposits increase and spontaneously create a credit amount.

If the member chooses to apply to the platform for a loan amount, he fills out a loan-amount application form on-line and sends the form to the node system. Then, the node transfers the form to the platform, and the platform examines the data in the form and determines whether or not to approve the loan-amount application (Step 307). If the application data passes, the platform assigns a loan amount to the member (Step 308). The member will determine whether the loan amount is sufficient (Step 310). If the member determines the loan amount is sufficient, he enters the platform to attend fund-bidding pools (Step 313) and bid within the range of the loan amount. If the member determines the loan amount is insufficient, he determines whether or not to apply to the node for a loan amount (Step 309). If the member chooses not to apply to the node for a loan amount, he enters the platform with the loan amount. Because of the insufficient loan amount, the member cannot acquire an intended amount of funds from the fund bidding in the platform until he applies to the node for a sufficient loan amount and acquires the loan amount or until his deposits increase and spontaneously create a sufficient credit amount. If the member chooses to apply to the node for a loan amount, the node examines the data the member provided earlier and the credit analysis data the node system acquires from the platform system (Step 311). If the data passes, the node assigns a loan amount to the member and acknowledges the platform (Step 312). Then, the member enters the platform (Step 313) with the loan amounts the platform and the node assign to him and bids in fund-bidding pools. If the data does not pass the examination of the node, the member can only enter the platform (Step 313) with the loan amount the platform assigns to him. Because of the insufficient loan amount, the member cannot acquire an intended amount of funds from the fund bidding in the platform until he acquires a sufficient loan amount later or until his deposits increase and spontaneously create a sufficient credit amount.

If the platform determines not to approve the loan-amount application (Step 307), the member should decide whether to apply to the node for a loan amount (Step 309). If the member chooses not to apply to the node for a loan amount, he enters the platform (Step 313) without any loan amount. Because of not having any loan amount, the member cannot attend the fund bidding in the platform until he acquires a loan amount later or until his deposits increase and spontaneously create a sufficient credit amount. If the member chooses to apply to the node for a loan amount (Step 309), the node examines the data the member provided earlier and the credit analysis data the node system acquires from the platform system (Step 311). If the data passes, the node assigns a loan amount to the member and acknowledges the platform (Step 312). Then, the member enters the platform (Step 313) with the loan amounts the node assigns to him and bids in fund-bidding pools. If the data does not pass the examination of the node, the member can only enter the platform (Step 313) without any loan amount. Because of not having any loan amount, the member cannot attend the fund bidding in the platform until he acquires a loan amount later or until his deposits increase and spontaneously create a sufficient credit amount.

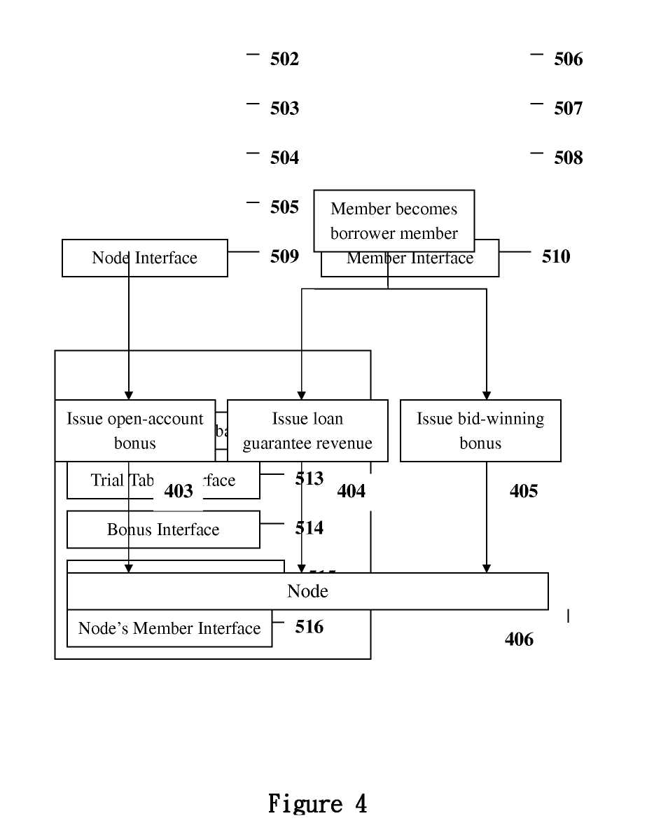

Refer to FIG. 4, which is a flowchart showing the method of acquiring income and bonus according to an embodiment of the present invention. A node is responsible for marketing, establishing accounts and providing service for the floating-rate fund-trading platform, or even providing loan amounts for members and guaranteeing the loan amounts. Therefore, the platform has a reward mechanism to reward the nodes. When an applicant passes the examination of the platform and establishes an account in the platform via a node (Step 401), the platform awards the node (406) an open-account bonus (Step 403). When a member attends a fund-bidding pool, wins a bid and becomes a borrower member (Step 402), the platform awards the node (406) a bid-winning bonus (Step 405). When the loan amount of a member is provided by the node partially or totally, the platform issues a loan-guarantee income to the node according to the proportion of the node-guaranteed loan amount (Step 404). The open-account bonus is to reward the node for its work in recruiting a member and providing account-opening service to the member. The bid-winning bonus is to reward the node for its service and instruction in the member's attending a fund-bidding pool and bidding in the fund-bidding group. A node providing a loan amount for a member means the node risks guaranteeing the loan amount for the member. Therefore, the platform issues a loan-guarantee income to the node according to the proportion of the node-guaranteed loan amount.

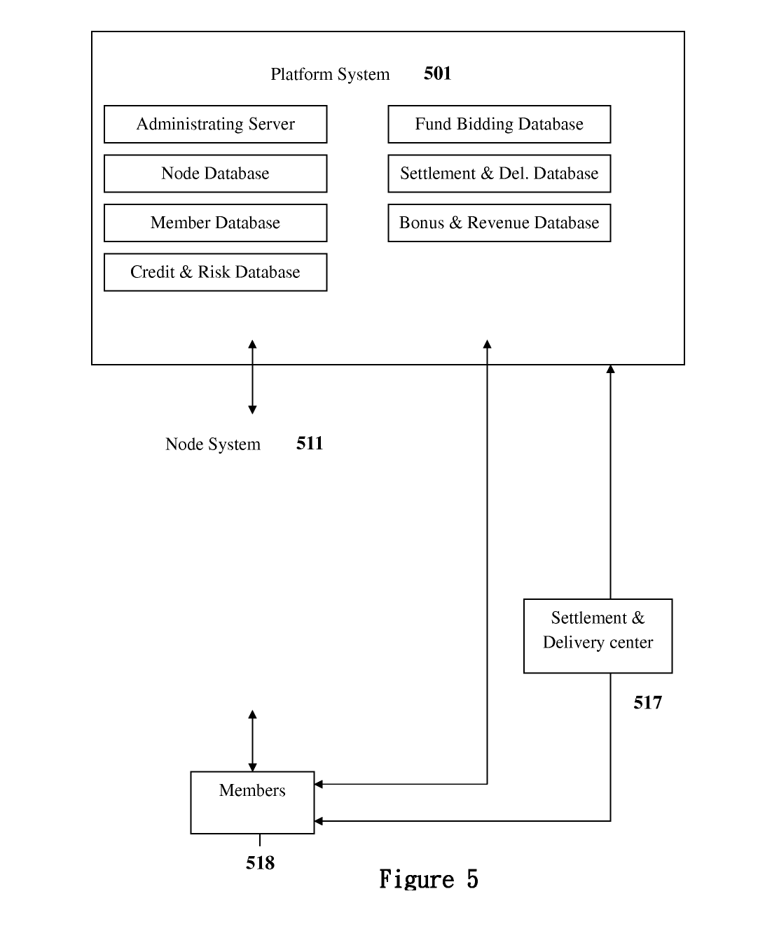

Refer to FIG. 5, which is a drawing illustrating a remote transaction system of an on-line platform for auctioning of money according to an embodiment of the present invention. The system of the present invention comprises: an on-line platform for auctioning of money (501), at least one node system (511) and a settlement and delivery center (517). The platform (501) comprises an administrating server (502), which links to members (518) via a member interface (510), links to node system (511) via a node interface (509) and links to a settlement and delivery center (517). The administrating server examines a node intending to attend the platform and assigns an appropriate loan amount to the node in response to the node's requirement. The administrating server examines members' application data that a node sends to the platform and undertakes credit analysis and examination of loan applications. The administrating server processes members' logging into the platform, members' attending fund-bidding pools, the settlement and delivery of members' funds with the settlement and delivery center, and the calculation and allocation of revenue and bonuses for nodes. The floating-rate fund-trading platform system further comprises: a node database (503), a member database (504), a credit and risk management database (505), a fund-bidding pool database (506), a settlement and delivery database (507) and a bonus and income database (508). The node database (503) stores the node-related information acquired in the information exchange between the administrating server and the node systems, such as the results of credit analysis and loan amount assignment the administrating server performs on nodes; and the platform uses the information in monitoring the node. The member database (504) stores the members' data input by nodes and the results of credit analysis and loan amount assignment the administrating server performs on members. The credit and risk management database (505) stores the data of credit analysis and loan amount assignment the administrating server performs on nodes and members. The fund-bidding pool database (506) stores the fund-bidding pool information, such as the bid prices input by members and the data of bid examinations performed by the administrating server. The settlement and delivery database (507) stores the data of settlement and delivery between the administrating server and the settlement and delivery center. The bonus and income database (508) stores the data of bonuses and revenue for nodes processed by the administrating server.

The administrating server safely exchanges information in real-time with members, nodes, and the settlement and delivery center via a communication network, a wireless communication device or a wired communication device. The administrating server is coupled to the databases and respectively stores data, information and results into the related databases.

The node system (511) comprises a subordinate member database (512) storing the fundamental data, credit analysis data, loan amount data, and fund-bidding data of the subordinate members. The node system comprises four interfaces: a loan amount trial table interface (513), a bonus and income interface (514), a node's working interface (515) and a node's member interface (516). Via the loan amount trial table interface (513), the node exchanges with the administrating server the information of the loan amounts of the node itself and the subordinate members. Via the bonus and income interface (514), the node exchanges with the administrating server the information of the bonuses and revenue of the node itself. On the node's working interface (515), the node arranges the subordinate members' data and the bonus and income data of the node itself. Via the node's member interface (516), the subordinate member of the node links to the node interface of the platform system to open an account, and apply for a loan amount, etc.

The node system safely exchanges information in real-time with members and the platform system via a communication network, a wireless communication device or a wired communication device. The node system is coupled to the database of the node itself and the databases of the platform system and respectively stores data, information and results into the related databases.

Following are three example embodiments to demonstrate the present invention.

### Embodiment I

As Mr. A is a subdivision head in a city district, he is very familiar with the backgrounds of the citizens living in his subdivision and understands their needs for funds. Therefore, Mr. A planned to become a node of the floating-rate fund-trading platform so that he can enhance his local community. Thus, Mr. A applied to the platform to become a node on a node interface via the Internet. After carefully examining Mr. A's data, the platform approved Mr. A's application for becoming a node (referred to as Node A hereafter). Then, the platform queried whether Node A wants to apply for a loan amount. As Node A did not intend to guarantee loans for members, it chose not to apply for a loan amount.

Then, Mr. A announced the new service to the citizens living in his subdivision. Citizen B requires a fund of NT$200,000 and intends to attend a fund-bidding pool having a period of two years and a contribution amount of at most NT$10,000. Node A helped Citizen B to open on-line a platform account and a settlement and delivery account. After receiving Citizen B's application, the platform examined whether Citizen B qualifies. After Citizen B passed the examination, the platform transferred the result to the system of Node A via a network. Then, Citizen B became a member of the floating-rate fund-trading platform (referred to as Member B hereafter). The node system presented a webpage to query whether Member B wants to apply for a loan amount. If Member B intends to apply for a loan amount in order to attend fund bidding, he fills out a loan amount application form on-line and sends the form to the node. Then, the node transfers the application data to the administrating server of the platform. The platform examines the application immediately. If the platform approves the application and assigns to Member B a loan amount of NT$300,000, Member B can attend the fund-bidding pool he applied to.

When Citizen B passes the examination and became a member of the platform, Node A acquires from the platform an open-account bonus rewarding Node A's work in recruiting a member and providing account-opening service to the member. When Member B won a bid in the fund-bidding pool, Node A acquires from the platform a bid-winning bonus rewarding Node A's service and instructing the member to bid in the fund-bidding pool.

### Embodiment II

Company C is a large enterprise with thousands of employees. To help the employees make the best of their money, Company C suggested the employees join the floating-rate fund-trading platform and become a node. Then, Company C applied on-line to the platform to become a node via the Internet. After examining Company C's data, the platform approved Company C's application for becoming a node (referred to as Node C hereafter). Node C applied to the platform for a loan amount. After an examination, the platform approved a loan amount of NT$30,000,000. Considering the number of the employees, Node C thought it was necessary to increase the loan amount. Thus, Node C applied to the platform for enhancing credit with a land mortgage. After examining the collateral, the platform determined that the land could increase a loan amount of NT$20,000,000. Thus, Node C had a fiduciary fundamental loan amount of NT$30,000,000 and a secured loan amount of NT$20,000,000, amounting to NT$50,000,000.

An Employee D of Company C needed a home loan and intended to attend a fund-bidding pool of a period of 20 years and a contribution amount of at most NT$10,000. Thus, Employee D applied to become a member of the floating-rate fund-trading platform. Via Node C, Employee D filled out an application form on-line to establish a platform account and a settlement and delivery account. After the platform approved Employee D's application, Employee D became a member of the platform (referred to as Member D hereafter). Then, Member D applied to the platform for a loan amount via Node C and filled out a loan amount application form on-line. After examination, the platform informed Member D through Node C that he had been assigned a loan amount of NT$2,000,000. However, the loan amount was insufficient for Member D because he needed a loan of NT$2,400,000. Thus, Member D turned to Node C for another loan amount. Node C itself had acquired the data of Employee D, and Node C further processed the credit analysis of Employee D via the link between the node system and the platform system. Then, Node C determined that it could provide Employee D with the shortage amount of NT$400,000. Thus, Node C agreed to assign Employee D a loan amount of NT$400,000 and acknowledged the result to the platform. After calculation, the platform determined that Node C had a residual loan amount of NT$49,600,000, and that the loan amount of Employee D was increased to NT$2,400,000.

Thus, Member D attended the fund-bidding pools of the platform with the above-mentioned loan amount. Since the account of Member D had been approved, the platform issued an open-account bonus to Node C for its work in recruiting a member and providing account-opening service to the member. If Member D won a bid and became a borrower member immediately at the first term, the platform issued a bid-winning bonus to Node C for its service and instructing Member D to attend fund-bidding pools. Among Member D's loan amount of NT$2,400,000, Node C guaranteed NT$400,000, about 16.6% of the total loan amount of Member D.

The platform issued a loan-guarantee income to Node C for Node C's risk share according to the proportion of the node-guaranteed loan amount.

### Embodiment III

Besides the floating-rate fund-trading platform, there is a settlement and delivery center processing the settlement and delivery between members and the platform. The platform of the present invention can be operated by a non-financial legal entity independently or by a financial organization, such as banks.

If the platform is operated by a non-financial legal entity independently, members establish their settlement and delivery accounts in banks (settlement and delivery banks) contracted with the platform, and the settlement and delivery of funds is undertaken by the settlement and delivery banks. The platform transmits the results of the fund-bidding pools to all the settlement and delivery banks. According to the data, the settlement and delivery banks undertake the settlements of related accounts and report the results to the platform.

If the platform is operated by a bank, the settlement and delivery center is the settlement and delivery section of the same bank, and the member's settlement and delivery account is the bank account. If the settlement and delivery center is not separated from the platform, all the members have to open accounts in the same bank, and the settlement and delivery accounts of members are all the accounts of the same bank, which inconveniences members very much.

In the present invention, it is to be noted that the settlement and delivery center is separated from the platform. Under this structure of the present invention, even if settlement and delivery is executed by the settlement and delivery section of a bank operating the platform, members can still open their accounts in other banks, and other banks will send back the results to the settlement and delivery section of the bank operating the platform (i.e. the settlement and delivery center) via the link there between, which exempts members from the above-mentioned inconvenience.

For example, suppose that Bank E manages the floating-rate fund-trading platform. Then, the settlement and delivery center is the settlement and delivery section of Bank E. Mr. F intends to attend the platform, but he only has an account at Bank G. There is linkage between the accounts of Bank E and Bank G in the platform. Therefore, Mr. F may directly use his account in Bank G as the settlement and delivery account of the platform. If Mr. F has made a deal in the platform, he can directly deposit or withdraw money via his account in Bank G. Then, Bank G sends the result back to the settlement and delivery section of Bank E to complete settlement and delivery.

It will be apparent to those skilled in the art that various modifications and variations can be made to the present invention without departing from the scope or spirit of the invention. In view of the foregoing, it is intended that the present invention encompass modifications and variations of this invention provided they fall within the scope of the invention and its equivalent.

What is claimed is:

1. A fund transaction method implemented on a transaction system, wherein the transact system comprises an administrating server, comprising steps of:
(A) configuring the administrating server to receive an application from a first user to be a platform node;
(B) configuring the administrating server to set a node credit line of the first user;
(C) configuring the administrating server to receive an application from a second user to be one of platform members;
(D) configuring the administrating server to receive an application from a third user guaranteed by the platform node to be one of platform members;
(E) configuring the administrating server to set a member credit line of the platform member; and
(F) configuring the administrating server to accept the platform member participating in a fund bidding transaction;
wherein the deficiency of the third user's credit line in the fund bidding transaction is guaranteed by the platform node according to the node credit line thereof.

2. The fund transaction method according to claim 1, further comprising the steps of:
(G) configuring the administrating server to determine a first reward the platform deserved according to the number of the platform members the platform nodes recruited;
(H) configuring the administrating server to determine a second reward the platform deserved according to a fund bidding transaction result of the platform member the platform nodes recruited; and
(I) configuring the administrating server to determine a third reward the platform node deserved according to the amount of credit line that is guaranteed by the platform node.

3. The fund transaction method according to claim 1, wherein the fund bidding transaction further comprising the steps of:
(F1) configuring the administrating server to accept the platform member participating in an fund combination to be one of combination members thereof, wherein the fund combination has N combination members and proceeds with N terms;
(F2) configuring the administrating server to receive a bid price submitted by the combination member in a n-th term;
(F3) configuring the administrating server to determine a bid winner of the n-th term according to the whole bid prices submitted by the combination members thereof;
(F4) configuring the administrating server to transmit a first message to prompt a bid winner of the n-th term to obtain a combination fund; and
(F5) configuring the administrating server to transmit a second message to prompt a bid loser of the n-th term to pay a deposit, and transmit a third message to prompt a bid winner of the anterior term to pay a repayment;
wherein the amount of the combination fund of the n-th term is a sum of the deposits and the repayments, and each combination member of the auction combination is limited to be once bid winner during the whole N terms thereof.

4. The fund transaction method according to claim 3, further comprises the step of:
(F6) configuring the administrating server to transmit a fourth message for charging a service fee from the bid winner.

5. The fund transaction method according to claim 3, wherein the amounts of the combination fund, the deposit, and the repayment of the fund combination are determined by the following formula:
An=(U−In)×((N−n))+(U×(n−1));
wherein An denotes the amount of the combination fund; U denotes a unit price; N denotes the total number of the terms of the auction combination; n denotes the number of n-th term; and In denotes the bid price submitted by the bid winner of the n-th term;
wherein the bid winner of the n-th term is provided with the combination fund and is prompted to pay U as the repayment price at every remaining repayment term; and the bid loser of the n-th term is prompted to pay (U−In) as the deposit.

6. The fund transaction method according to claim 3, wherein the amounts of the combination fund, the deposit, and the repayment are determined by the following formula:
$$An = ( U \times ( N - n ) ) + ( U \times ( n - 1 ) ) + {\sum }_{i = 1}^{n - 1} Ii ;$$
wherein An denotes the amount of the combination fund; U denotes a unit price; N denotes the total number of the terms of the auction combination; n denotes the number of n-th term; and Ii denotes the bid price submitted by the bid winner of the anterior i-th term; In denotes the bid price submitted by the bid winner of the n-th term;
wherein the bid winner of the n-th term is provided with the combination fund and is prompted to pay (U+In) as the repayment price at every remaining repayment term; and the bid loser of the n-th term is prompted to pay U as the deposit.

7. A remote transaction system of an on-line platform for auctioning of money with at least one node and a settlement and delivery center, wherein said platform comprising:
an administrating server which links to members via a platform member interface through Internet, wired communication devices, wireless communication devices, or local network, links to nodes via a node interface, and links to a settlement and delivery center, and which examines a node intending to attend said platform and assigns an appropriate loan amount to said node in accordance with said node's application, and which undertakes credit analysis and examination of members' loan applications sent via nodes to said platform, and which processes members' logging into said platform, and members' attending fund-bidding pools, settlement and delivery of members' funds with said settlement and delivery center, and calculation and allocation of revenue and bonuses for nodes, and which respectively stores data into related databases;
a node database storing node-related information acquired in information exchanged between said administrating server and said node systems, including results of credit analysis and loan amount assignment said administrating server performs on nodes, wherein said platform uses the foregoing information in said node database in monitoring nodes;
a member database storing members' data input by nodes and results of credit analysis and loan amount assignment said administrating server performs on members;
a credit and risk management database storing data of credit analysis and loan amount assignment said administrating server performs on nodes and members;
a fund-bidding group database storing fund-bidding pool information, including bid prices input by members and data of bid examinations performed by said administrating server;
a settlement and delivery database storing data of settlement and delivery between said administrating server and said settlement and delivery center;
a bonus and income database storing data of bonuses and revenue of nodes processed by said administrating server;
a node interface linking said platform system to said node system and processing data transmission between said platform and said node system; and
a member interface linking said platform to members and processing data transmission between said platform and members.

8. The system according to claim 7, wherein said node system further comprising:
a member database storing basic data, credit analysis data, loan amount data, and fund-bidding pool data of members of said node system.

9. The system according to claim 8, the node system further comprising:
a loan amount trial table interface whereby said node system exchanges with said administrating server information of loan amounts of said node system itself and of members of said node system.

10. The system according to claim 8, the node system further comprising:
a bonus and income interface whereby said node system exchanges with said administrating server information of bonuses and revenue of said node system itself.

11. The system according to claim 2, the node system further comprising:
a node's working interface whereby said node system arranges members' data and bonus and income data of said node system itself; and
a node's member interface whereby members of said node system link to said node interface of said platform system via the Internet to open accounts and apply for loan amounts.
